(19) United States
(12) Patent Application Publication
(10) Pub. No.: US 2013/0318040 A1
(43) Pub. Date: Nov. 28, 2013

(54) DATA REPLICATION APPARATUS AND METHOD USING HIERARCHICAL ORGANIZATION OF DATA SERVERS

(71) Applicant: ELECTRONICS AND TELECOMMUNICATIONS RESEARCH INSTITUTE, (US)

(72) Inventor: Jeong-Sook PARK, Daejeon (KR)

(73) Assignee: ELECTRONICS AND TELECOMMUNICATIONS RESEARCH INSTITUTE, Daejeon-city (KR)

(21) Appl. No.: 13/775,992

(22) Filed: Feb. 25, 2013

(30) Foreign Application Priority Data
May 22, 2012 (KR) 10-2012-0054153

(51) Int. Cl. G06F 17/30

(52) U.S. Cl. CPC G06F 17/30575
USPC 707/623

(57) ABSTRACT

Disclosed is a data replication technique using the hierarchical organization of data servers which is contrived to minimize a burden on a metadata server and also improve the performance of the entire system by operating data servers efficiently. To this end, a data replication method using the hierarchical organization of data servers in accordance with the present invention includes dividing a plurality of data servers into a primary data server group and a secondary data server group and managing, by a metadata server, information on the state of each data server group and metadata.

### CROSS-REFERENCE TO RELATED APPLICATION

This application claims the benefit of Korean Patent Application No. 10-2012-0054153, filed on May 22, 2012, which is hereby incorporated by reference in its entirety into this application.

### BACKGROUND OF THE INVENTION

1. Technical Field

Exemplary embodiments of the present invention relate to a data replication apparatus and method using the hierarchical organization of data servers; and, particularly, to a data replication apparatus and method using the hierarchical organization of data servers, which are contrived to minimize a burden on a metadata server and also improve the performance of the entire system by operating data servers efficiently.

2. Description of Related Art

A distributed file system is a system for separating, storing, and managing metadata that contains information on the attributes of a file and real data that forms the file. In this system, the metadata is managed in a metadata server, and the real data is distributed over a plurality of data servers and stored therein. The metadata includes information on the attributes of the file and information on the data servers in which the real data is stored. The metadata server and the plurality of data servers are connected over a network and distributed.

Accordingly, a path along which a client accesses the metadata of the file is separated from a path along which the client accesses the real data. In order to access the file, the client accesses the metadata of the file stored in the metadata server and then obtains the information on the plurality of data servers in which the real data is stored. The client performs data I/O (Input/Output) for the real data through parallel access along with the plurality of data servers based on the obtained information, thereby improving overall file access performance.

The data of a file may be stored in data servers connected over a network based on a file, or when the size of a file is large, the data of the file may be fragmented into a specific unit called a chunk and stored. Data distributed over and stored in data servers may improve the performance of a system through parallel access, but may have a problem in that access to the data is denied when a data server fails or a network failure occurs. A distributed file system uses a method of replicating and storing a file or chunks in another data server in preparation for a failure, such as the failure of a data server, so that there is no problem when providing service even when a specific node fails. It is inevitably a burden for a metadata server and a data server to perform this replication when performing data I/O. A client may also have a burden due to the slow response time of servers. A method using a replication-dedicated daemon may be taken into consideration, but this method may have a heavy burden on the metadata server which has a great amount of messages transmitted to and received from other nodes.

Accordingly, there is an urgent need for the development of a method of providing a scheme for providing a minimum response time to a client and also maximizing the performance of a distributed file system by contriving an efficient mechanism which can replicate data while minimizing a burden on a metadata server.

### SUMMARY OF THE INVENTION

An embodiment of the present invention is directed to providing an efficient data replication method in a distributed file system. That is, the present invention is directed to providing a data replication system which minimizes a burden on a metadata server and also improving the performance of the entire system by operating data servers efficiently.

Another embodiment of the present invention is directed to providing a minimum response time for the I/O command of a client.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a data replication apparatus using a hierarchical organization of data servers includes a primary data server group configured to include a plurality of primary data servers for providing service in response to a data write request of a client; a secondary data server group configured to include a plurality of secondary data servers for monitoring the primary data server group, replicating and storing data to be replicated when the data is written into the primary data server group, and providing service to a data read request of the client; and a metadata server configured to manage the metadata of the data stored in the primary data server group and the secondary data server group and manage information on the state of the primary data server group and the secondary data server group.

The primary data server group may return an error message to the client when a data read request message is received from the client.

The primary data server group may return a recommendation message, recommending that the client access the secondary data server group and read the data from the secondary data server group, to the client along with the error message.

When the writing of the data in the primary data server group is completed in response to the data write request of the client, the primary data server group may send a publication message, informing that there is the data to be replicated, to the secondary data server group. In response to the publication message, the secondary data server group may replicate the data, written into the primary data server group, by a specific number and store the replicated data in the specific number of secondary data servers, respectively.

The metadata server may provide the client with a list of the plurality of primary data servers when a request to write first data is received from the client, and provide the client with a list of a plurality of secondary data servers in which the replication data of second data is stored when a request to read the second data is received from the client.

Here, the primary data server group and the secondary data server group may report the information on the state to the metadata server at a predetermined time interval.

Here, the metadata of the data stored in the primary data server group may be directly reported to the metadata server, and the metadata of the data stored in the secondary data server group may be reported to the metadata server via the primary data server.

In accordance with another embodiment of the present invention, a data replication method using a hierarchical organization of data servers includes providing, by a primary data server group including a plurality of primary data servers, service in response to a data write request of a client; monitoring, by a secondary data server group including a plurality of secondary data servers, whether a data write task is performed in the primary data server group; replicating and storing, by the secondary data server group, written data if, as a result of the monitoring, the data write task has been performed in the primary data server group; managing, by a metadata server, the metadata of the data stored in the primary data server group and the secondary data server group, and information on the state of the primary data server group and the secondary data server group; and providing, by the secondary data server, service in response to a data read request of the client.

The data replication method may further include returning, by the primary data server group, an error message to the client when the client sends a data read request message to the primary data server group.

The returning, by the primary data server group, of an error message to the client when the client sends a data read request message to the primary data server group may include returning a recommendation message, recommending that the client access the secondary data server group and read the data from the secondary data server group, to the client along with the error message.

The replicating and storing, by the secondary data server group, of written data if, as a result of the monitoring, the data write task has been performed in the primary data server group may include sending, by the primary data server group, a publication message, informing that there is data to be replicated, to the secondary data server group when the data write task in the primary data server group is completed; replicating, by the secondary data server group, data written into the primary data server group by a specific number in response to the publication message; and storing, by the secondary data server group, the replicated data in the specific number of secondary data servers, respectively.

The replicating, by the secondary data server group, of data written into the primary data server group by a specific number in response to the publication message may include determining, by each of the plurality of secondary data servers of the secondary data server group, its own availability and returning, by each of the plurality of secondary data servers of the secondary data server group, a data replication intention message to the primary data server group in response to the publication message; reporting, by the primary data server group, a list of secondary data servers that have sent the replication intention messages to the metadata server; selecting, by the metadata server, a specific number of secondary data servers from the secondary data servers that have sent the replication intention messages; and replicating, by each of the selected secondary data servers, the data written into the primary data server group.

The data replication method may further include providing, by the metadata server, the client with a list of the plurality of primary data servers when a request to write first data is received from the client and providing, by the metadata server, the client with a list of secondary data servers in which the replication data of second data is stored when a request to read the second data is received from the client.

The managing, by a metadata server, of metadata of the data stored in the primary data server group and the secondary data server group, and information on a state of the primary data server group and the secondary data server group may include receiving the information on the state from the primary data server group and the secondary data server group at a predetermined time interval.

The managing, by a metadata server, of metadata of the data stored in the primary data server group and the secondary data server group and information on a state of the primary data server group and the secondary data server group may include directly receiving a report on the metadata of data, stored in the primary data server group, from the primary data server group and receiving a report on the metadata of data, stored in the secondary data server group, from the secondary data server group via the primary data server.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows a schematic diagram of the general system of a data replication apparatus using the hierarchical organization of data servers in accordance with an embodiment of the present invention;

FIG. 2 is a flowchart illustrating the operation of a primary data server group in a data replication method using the hierarchical organization of data servers in accordance with an embodiment of the present invention;

FIG. 3 is a flowchart illustrating the operation of a secondary data server group in the data replication method using the hierarchical organization of data servers in accordance with an embodiment of the present invention;

FIG. 4 is a flowchart illustrating the operation of a metadata server in the data replication method using the hierarchical organization of data servers in accordance with an embodiment of the present invention; and

FIG. 5 is a flowchart illustrating the operation of a client in the data replication method using the hierarchical organization of data servers in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

A data replication apparatus, using the hierarchical organization of data servers in accordance with an embodiment of the present invention, is described below.

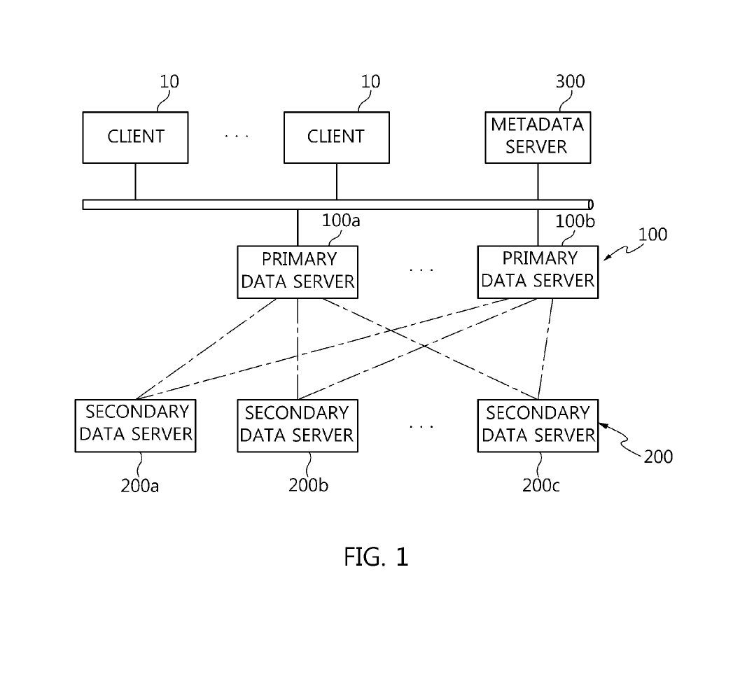

FIG. 1 shows a schematic diagram of the general system of a data replication apparatus using the hierarchical organization of data servers in accordance with an embodiment of the present invention.

Referring to FIG. 1, the data replication apparatus, using the hierarchical organization of data servers in accordance with the present invention, includes a primary data server group 100, a secondary data server group 200, and a metadata server 300.

The primary data server group 100 includes a plurality of primary data servers 100a and 100b for providing service in response to the data write request of a client 10. FIG. 1 illustrates only the two primary data servers 100a and 100b, but the number of primary data servers is not limited to two.

The primary data server group 100 returns an error message to the client 10 in response to a data read request message from the client 10. That is, the primary data server group 100 provides corresponding service only in response to the data write request of the client 10. Here, the primary data server group 100 can return a recommendation message, recommending that the client 10 access the secondary data server group 200 and read data therefrom, to the client 10 along with an error message.

In the secondary data server group 200, a plurality of secondary data servers 200a, 200b, and 200c monitors the primary data server group 100. If data to be replicated is written into the primary data server group 100, the plurality of secondary data servers 200a, 200b, and 200c replicates and stores the data. Furthermore, in the secondary data server group 200, the plurality of secondary data servers 200a, 200b, and 200c provides service in response to the data read request of the client 10. FIG. 1 illustrates only the three secondary data servers 200a, 200b, and 200c, but the number of secondary data servers is not limited to three.

The metadata server 300 manages the metadata of data stored in the primary data server group 100 and the secondary data server group 200. Here, the metadata server 300 receives a report on the metadata of data, stored in the primary data server group 100, from the primary data server group 100 directly. Furthermore, the metadata server 300 receives a report on the metadata of data, stored in the secondary data server group 200, via the primary data server group 100 indirectly. Accordingly, a burden on the metadata server 300 can be reduced because the number of data servers directly managed by the metadata server 300 is reduced.

Furthermore, the metadata server 300 manages information on the state of the primary data server group 100 and the secondary data server group 200. Here, the metadata server 300 can receive a report on the information on the state from the primary data server group 100 and the secondary data server group 200 at a specific time interval.

When a request to write first data is received from the client 10, the metadata server 300 provides a list of the plurality of primary data servers 100a and 100b to the client 10. The client 10 can perform a task of writing the first data with reference to the list of the plurality of primary data servers 100a and 100b. Furthermore, when a request to write second data is received from the client 10, the metadata server 300 provides the client 10 with a list of the plurality of secondary data servers 200a, 200b, and 200c in which the replication data of the second data is stored. The client 10 can perform a task of reading the second data with reference to the list of the plurality of secondary data servers 200a, 200b, and 200c.

In the data replication apparatus using the hierarchical organization of data servers in accordance with the present invention, the operation of each of the elements when the client 10 performs a data write task is described below.

First, when the writing of data in the primary data server group 100 is completed in response to the data write request of the client 10, the primary data server group 100 sends a publication message, informing that there is a data to be replicated, to the secondary data server group 200. In response to the publication message, each of the plurality of secondary data servers 200a, 200b, and 200c of the secondary data server group 200 determines its own availability and sends a data replication intention message to the primary data server group 100 if, as a result of the determination, there is availability for data replication. Next, the primary data server group 100 reports a list of the secondary data servers that have sent the replication intention messages to the metadata server 300. The metadata server 300 selects a specific number of secondary data servers from the secondary data servers that have sent the replication intention messages. Next, each of the selected secondary data servers replicates the corresponding data written into the primary data server group 100.

As described above, the distributed file system of the present invention includes the clients 10, the primary data server group 100, the secondary data server group 200, and the metadata server 300. Accordingly, system performance can be improved because a control path and a data path are separated from each other and data is accessed at the same time. That is, data write/read operations can be performed at the same time because the plurality of data servers is divided into the primary data servers and the secondary data servers, and system performance can be improved because data replication is performed underground.

Furthermore, a burden on the metadata server 300 can be minimized because the metadata server 300 does not directly communicate with the secondary data server group 200 and thus the number of nodes directly managed by the metadata server 300 is reduced.

In a data replication method using the hierarchical organization of data servers in accordance with an embodiment of the present invention, the operations of the primary data server group 100, the secondary data server group 200, the metadata server 300, and the client 10 are described in detail below.

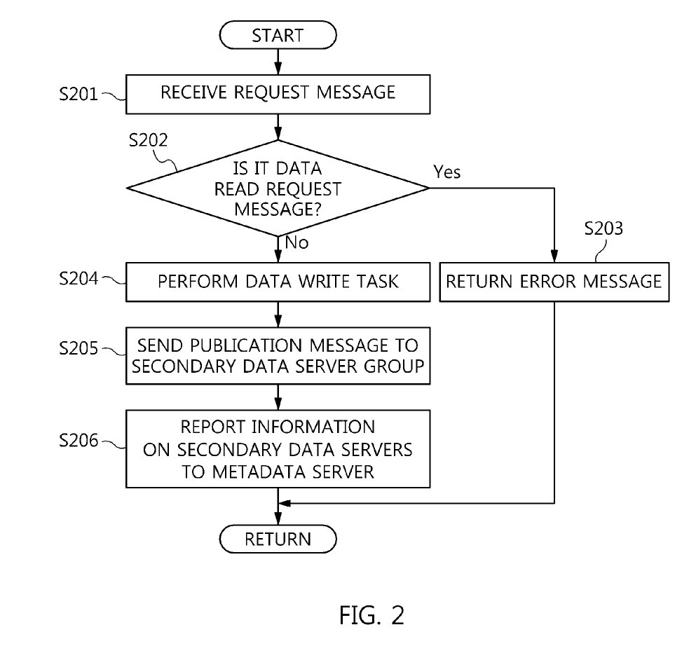

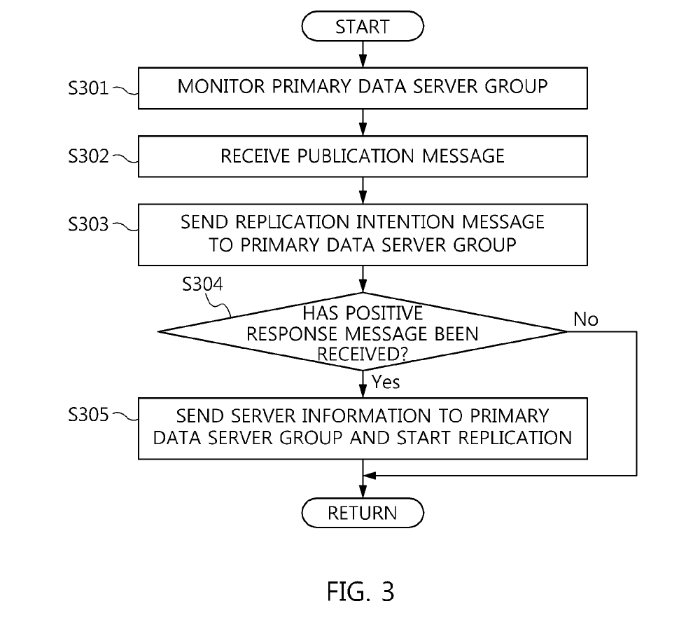

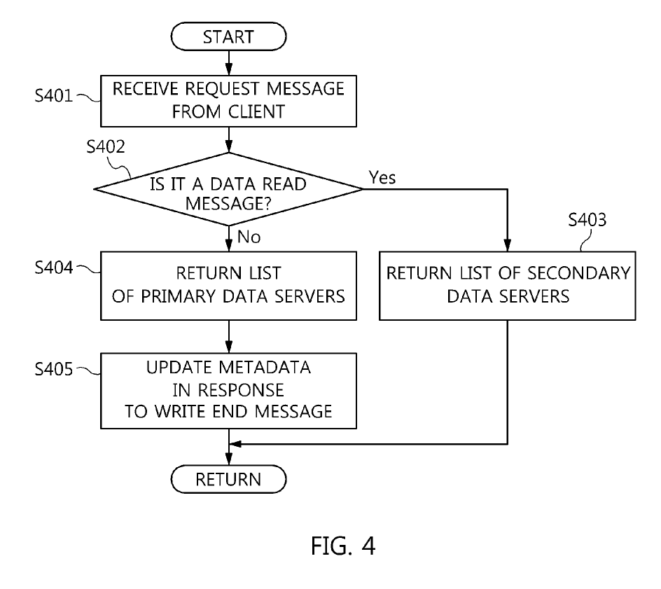

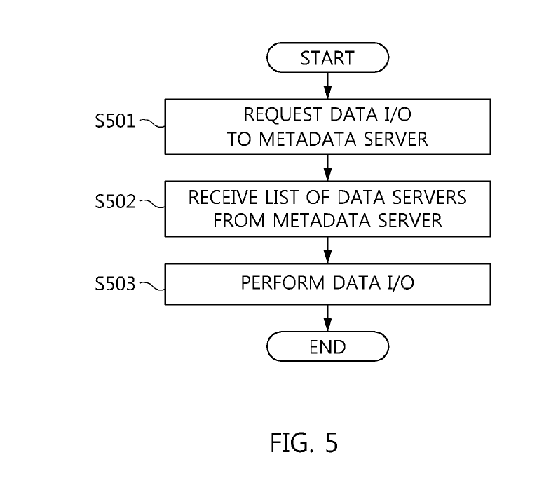

FIG. 2 is a flowchart illustrating the operation of the primary data server group 100 in a data replication method using the hierarchical organization of data servers in accordance with an embodiment of the present invention. FIG. 3 is a flowchart illustrating the operation of the secondary data server group 200 in the data replication method using the hierarchical organization of data servers in accordance with an embodiment of the present invention. FIG. 4 is a flowchart illustrating the operation of the metadata server 300 in the data replication method using the hierarchical organization of data servers in accordance with an embodiment of the present invention. FIG. 5 is a flowchart illustrating the operation of a client in the data replication method using the hierarchical organization of data servers in accordance with an embodiment of the present invention.

Referring to FIG. 2, in the data replication method using the hierarchical organization of data servers in accordance with the present invention, the primary data server group 100 operates as follows.

First, the primary data server group 100 receives a request message from the metadata server 300 or the client 10 at step S201.

The primary data server group 100 determines whether the request message at step S201 is a data read request message or not at step S202.

If, as a result of the determination at step S202, it is determined that the request message is the data read request message, the primary data server group 100 returns an error message at step S203. Here, the primary data server group 100 can return a recommendation message, recommending that a data read task be performed through access to the secondary data server group 200, along with the error message.

If, as a result of the determination at step S202, it is determined that the request message is a data write request message and not the data read request message, service is provided to the primary data server group 100 so that a data write task is performed in response to the request message at step S204.

When the data write task of the primary data server group 100 is completed at step S204, the primary data server group 100 sends a publication message, informing that there is data to be replicated, to the secondary data server group 200 at step S205.

Next, the primary data server group 100 reports a list of secondary data servers that have sent replication intention messages in response to the publication message at step S205 to the metadata server 300 at step S206. When the metadata server 300 selects a specific number of the secondary data servers, the selected secondary data servers replicate the data written into the primary data server group 100.

Referring to FIG. 3, in the data replication method using the hierarchical organization of data servers in accordance with the present invention, the secondary data server group 200 operates as follows.

First, the secondary data server group 200 monitors whether a data write task is performed in the primary data server group 100 at step S301.

Next, the secondary data server group 200 receives a publication message, informing that there is data to be replicated, from the primary data server group 100 at step S302.

In response to the publication message at step S302, the secondary data server group 200 determines the availability of each of the secondary data servers and sends data replication intention messages to the primary data server group 100 at step S303.

Next, the secondary data server group 200 determines whether or not a replication positive response message is received from the metadata server 300 via the primary data server group 100 at step S304. That is, the secondary data server group 200 determines whether or not the metadata server 300 has selected the secondary data servers as data servers that will replicate the data to be replicated.

If, as a result of the determination at step S304, it is determined that the metadata server 300 selects the secondary data servers as the data servers that will replicate the data to be replicated, each of the selected secondary data servers sends its own information to the primary data server group and replicates the data written into the primary data server group at step S305.

Referring to FIG. 4, in the data replication method using the hierarchical organization of data servers in accordance with the present invention, the metadata server 300 operates as follows.

First, the metadata server 300 receives a request message from the client 10 at step S401.

The metadata server 300 determines whether the request message received at step S401 is a data read request message or not at step S402.

If, as a result of the determination at step S402, it is determined that the received request message is the data read request message, the metadata server 300 provides the client 10 with a list of the secondary data servers in which the replication data of corresponding data is stored at step S403. The client 10 reads the corresponding data with reference to the list of the secondary data servers in which the replication data of the corresponding data is stored.

If, as a result of the determination at step S402, it is determined that the received request message is a data write request message, the metadata server 300 provides the client 10 with a list of the primary data servers at step S404. The client 10 writes data with reference to the list of the primary data servers. The data written into the primary data servers is replicated and stored by the secondary data server group 200.

After the writing of the data is completed, the client 10 updates the metadata of the written data at step S405. More particularly, the metadata server 300 updates the metadata of the primary data servers in which the data has been written and the metadata of the secondary data servers to which the data has been replicated and in which the replicated data is stored.

Referring to FIG. 5, in the data replication method using the hierarchical organization of data servers in accordance with the present invention, the client 10 operates as follows.

First, the client 10 requests data I/O from the metadata server 300 at step S501.

Next, the client 10 receives a list of data servers corresponding to the data I/O from the metadata server 300 at step S502. Here, if the client 10 makes a request to write data, the metadata server 300 provides the client 10 with a list of the plurality of primary data servers included in the primary data server group 100. If the client 10 makes a request to read data, the metadata server 300 provides the client 10 with a list of the secondary data servers in which the replication data of corresponding data is stored.

Next, the client 10 performs a data 110 task using the list of the data servers received at step S502, at step S503.

In accordance with the exemplary embodiments of the present invention, an efficient data replication method in a distributed file system can be provided because the data server groups are hierarchically managed. That is, in accordance with the present invention, the data replication system having improved performance can be provided because a burden on the metadata server is minimized and data servers are efficiently operated.

Furthermore, in accordance with the present invention, a minimum response time for the 110 commands of the client can be provided.

Furthermore, in accordance with the present invention, overall performance of the data replication system can be improved because a control path and a data path are separated from each other and data is distributed over and stored in a plurality of data servers.

While the present invention has been described with respect to the specific embodiments, it will be apparent to those skilled in the art that various changes and modifications may be made without departing from the spirit and scope of the invention as defined in the following claims.

What is claimed is:

1. A data replication apparatus using a hierarchical organization of data servers, comprising:
a primary data server group configured to comprise a plurality of primary data servers for providing service in response to a data write request of a client;
a secondary data server group configured to comprise a plurality of secondary data servers for monitoring the primary data server group, replicating and storing data to be replicated when the data is written into the primary data server group, and providing service to a data read request of the client; and
a metadata server configured to manage metadata of the data stored in the primary data server group and the secondary data server group and manage information on a state of the primary data server group and the secondary data server group.

2. The data replication apparatus of claim 1, wherein the primary data server group returns an error message to the client when a data read request message is received from the client.

3. The data replication apparatus of claim 2, wherein the primary data server group returns a recommendation message, recommending that the client access the secondary data server group and read the data from the secondary data server group, to the client along with the error message.

4. The data replication apparatus of claim 1, wherein:
when the writing of the data in the primary data server group is completed in response to the data write request of the client, the primary data server group sends a publication message, informing that there is data to be replicated, to the secondary data server group, and
in response to the publication message, the secondary data server group replicates the data, written into the primary data server group, by a specific number and stores the replicated data in the specific number of secondary data servers, respectively.

5. The data replication apparatus of claim 1, wherein the metadata server provides the client with a list of the plurality of primary data servers when a request to write first data is received from the client and provides the client with a list of a plurality of secondary data servers in which replication data of second data is stored when a request to read the second data is received from the client.

6. The data replication apparatus of claim 1, wherein the primary data server group and the secondary data server group report the information on the state to the metadata server at a predetermined time interval.

7. The data replication apparatus of claim 1, wherein:
metadata of the data stored in the primary data server group is directly reported to the metadata server, and
metadata of the data stored in the secondary data server group is reported to the metadata server via the primary data server.

8. A data replication method using a hierarchical organization of data servers, comprising:
providing, by a primary data server group comprising a plurality of primary data servers, service in response to a data write request of a client;
monitoring, by a secondary data server group comprising a plurality of secondary data servers, whether a data write task is performed in the primary data server group;
replicating and storing, by the secondary data server group, written data if, as a result of the monitoring, the data write task has been performed in the primary data server group;
managing, by a metadata server, metadata of the data stored in the primary data server group and the secondary data server group and information on a state of the primary data server group and the secondary data server group; and
providing, by the secondary data server, service in response to a data read request of the client.

9. The data replication method of claim 8, further comprising returning, by the primary data server group, an error message to the client when the client sends a data read request message to the primary data server group.

10. The data replication method of claim 9, wherein the returning, by the primary data server group, of an error message to the client when the client sends a data read request message to the primary data server group comprises returning a recommendation message, recommending that the client access the secondary data server group and read the data from the secondary data server group, to the client along with the error message.

11. The data replication method of claim 8, wherein the replicating and storing, by the secondary data server group, of written data if, as a result of the monitoring, the data write task has been performed in the primary data server group comprises:
sending, by the primary data server group, a publication message, informing that there is data to be replicated, to the secondary data server group when the data write task in the primary data server group is completed;
replicating, by the secondary data server group, data written into the primary data server group by a specific number in response to the publication message; and
storing, by the secondary data server group, the replicated data in the specific number of secondary data servers, respectively.

12. The data replication method of claim 11, wherein the replicating, by the secondary data server group, of data written into the primary data server group by a specific number in response to the publication message comprises:
determining, by each of the plurality of secondary data servers of the secondary data server group, its own availability and returning, by each of the plurality of secondary data servers of the secondary data server group, a data replication intention message to the primary data server group in response to the publication message;
reporting, by the primary data server group, a list of secondary data servers that have sent the replication intention messages to the metadata server;
selecting, by the metadata server, a specific number of secondary data servers from the secondary data servers that have sent the replication intention messages; and
replicating, by each of the selected secondary data servers, the data written into the primary data server group.

13. The data replication method of claim 8, further comprising:
providing, by the metadata server, the client with a list of the plurality of primary data servers when a request to write first data is received from the client; and
providing, by the metadata server, the client with a list of secondary data servers in which replication data of second data is stored when a request to read the second data is received from the client.

14. The data replication method of claim 8, wherein the managing, by a metadata server, of metadata of the data stored in the primary data server group and the secondary data server group and information on a state of the primary data server group and the secondary data server group comprises receiving the information on the state from the primary data server group and the secondary data server group at a predetermined time interval.

15. The data replication method of claim 8, wherein the managing, by a metadata server, of metadata of the data stored in the primary data server group and the secondary data server group and information on a state of the primary data server group and the secondary data server group comprises:
directly receiving a report on metadata of data, stored in the primary data server group, from the primary data server group; and
receiving a report on metadata of data, stored in the secondary data server group, from the secondary data server group via the primary data server.
